(19) United States
(12) Patent Application Publication
(10) Pub. No.: US 2008/0175968 A1
(43) Pub. Date: Jul. 24, 2008

(54) DEVICE AND METHOD FOR PRODUCING FOOD PATTIES WITH SEALED IN INGREDIENTS

(76) Inventors: Edward J. Bloom, Rumson, NJ (US); Gregory C. Dua, Clark, NJ (US)

Correspondence Address: OSTROLENK FABER GERB & SOFFEN, 1180 AVENUE OF THE AMERICAS, NEW YORK, NY, 100368403, US

(21) Appl. No.: 12/047,012

(22) Filed: Mar. 12, 2008

Related U.S. Application Data
(63) Continuation-in-part of application No. 12/016,666, filed on Jan. 18, 2008.
(60) Provisional application No. 60/885,488, filed on Jan. 18, 2007.

(51) Int. Cl. A23L 1/48; A23P 1/10

(52) U.S. Cl. 426/512; 99/494

(57) ABSTRACT

A device for installing an ingredient inside a food patty, the device including first and second hinged together patty portion receptacles, and a die support with a respective patty portion shaping die for each of the patty portions in the receptacles. The dies are closed into the receptacles to shape the patty portions therein to define a respective pocket in each patty portion for holding an ingredient. With the ingredient installed in a pocket formed in one of or each of the patties, the patty portion receptacles are hingedly movable together to combine the patty portions into a patty containing the installed ingredient. The patty remains in one receptacle. A patty portion release device at one or each receptacle releases the patty portions from the respective receptacles. For example, one receptacle is of a non-stick material and/or is deformable to release the patty portion material therein.

### CROSS-REFERENCE TO RELATED APPLICATIONS

This application is a continuation in part of U.S. application Ser. No. 12/016,666, filed Jan. 18, 2008, which is based on and claims priority of U.S. Provisional Patent Application Ser. No. 60/885,488 filed Jan. 18, 2007, the disclosures of which are incorporated by reference.

### BACKGROUND OF THE INVENTION

The present invention concerns a device for enabling additional ingredients to be enclosed in and sealed into the interior of a food patty, such as a hamburger patty or a patty of another shapable or moldable food product, during the shaping and forming process. The invention also concerns a method for producing such a patty. The invention has particular application during formation of a hamburger patty, and can be used for enclosing ingredients in a patty made of any shapable food products, typically any chopped product, of meat, fish or vegetable. Although the following description refers to a hamburger patty, that is an example of a food for which the invention may be used.

A hamburger is comprised of chopped meat which is shaped into a patty that may be round, square or otherwise shaped. Spices and flavorings may be added to the hamburger meat before it is shaped into a patty and may be mixed in throughout the patty material. Spices, flavorings and additional ingredients such as cheese, vegetables like pickles, or tomatoes or beans, seasonings, spices, condiments, including tomato ketchup, sauces, etc. are often added to a patty by being applied to its exterior, usually on the top, either prior to cooking the completed formed patty or subsequent to cooking. It may be desirable to create a different style of patty or to retain the additional ingredients inside the patty rather than outside it for several reasons, including improved controlled taste of the eventually cooked patty, neatness, cleanliness and prevention of the additional ingredients falling off the patty or being lost. For these and other reasons, it may be desirable to apply additional ingredients so they will be held inside the uncooked patty, and preferably to apply the ingredients during formation of the patty, so that the additional ingredients will be contained within the completed patty and may be cooked to the extent that the heat of the cooking will reach them.

It is apparent that something may be placed inside a hamburger or other food material patty by forming the patty of a first portion of patty material, applying the additional ingredient to a surface of the first portion and then applying a second portion of patty material over the additional ingredient. Another technique for installing an additional ingredient inside a patty is to form an entry hole through a top, or bottom surface or side of the patty and there insert the additional ingredient. This technique may not be easy to practice, may not distribute the ingredient as uniformly or widely as desired and may not permit positioning of the ingredient inside the patty where desired.

There are known devices for forming hamburgers and other patties that include an additional ingredient within the patty. U.S. Pat. No. 6,386,854 shows a base and a lid that forms an indentation in a first patty portion in which the additional ingredient may be deposited. Subsequently, the first patty portion with the additional ingredient is covered by another patty portion and they are sealed at the edges, creating an enclosed ingredient containing patty.

Filling a patty from a side is shown in U.S. Pat. No. 3,909,881. Supplying an additional ingredient into a hamburger patty is also shown in U.S. Pat. Nos. 3,913,175 and 4,106,162 and Design Pat. 369,948. A simple device including relatively movable parts for forming a patty of hamburger etc. and installing ingredients is not shown in the art.

### SUMMARY OF THE INVENTION

It is an object of the invention to form a hamburger or other food material patty which encloses an additional ingredient within the patty during the forming process. It is another object to close the edges of the hamburger or patty after the additional ingredient has been installed.

According to the invention, a hamburger producing and ingredient enclosing device is preferably a single unit comprised of three hinged together parts, although the described parts may not all be connected. These parts include two patty portion receptacles and a forming die part which is pressed on a patty portion placed in at least one of the receptacles or the portions in both receptacles and shapes the patty portion for enabling it to receive the additional ingredient.

The patty formed using the invention may be comprised of chopped meat or hamburger meat or of any other chopped or moldable edible material, including fish and vegetable, in which patty it is desired to place an additional ingredient before cooking or further treatment of the patty.

The device of the invention includes first and second supports including patty receptacles therein. Each receptacle includes a recess for receiving a portion of the patty material of which the final patty will be comprised. Each portion of patty material has an exposed side at the open side of the recess in the receptacle. It is intended to form a pocket or recess in the exposed side of at least one, and preferably in the exposed sides of both, patty portions.

A shaping die for one of the patty portions or a respective shaping die for each of the patty portions is or are supported on a die support at such locations on the die support that the respective die or dies can be moved over the patty portion receptacles and can be pressed into the patty material in the recess of the respective receptacle. The die is shaped to define a pocket in the patty material. After the die forms the pocket or recess, it is moved off the receptacles. An additional ingredient may then be installed in the pocket in the receptacle.

To shape the patty and to eliminate from the final patty excess material which either did not enter the recess or is squeezed or expressed from the recess during the patty forming process, the recess is surrounded by an upstanding wall which cooperates with the other recess so that the wall defines a periphery of the patty portion.

After an additional ingredient has been supplied to the pocket or recess in the patty portion, the open side of one patty portion receptacle is placed over the open side of the other patty portion receptacle and they are pressed together. The pressing together of the receptacles causes at least the peripheral areas of the patty portions to come together, and the peripheral wall around one of the receptacles, closes the peripheral edge of the patty with the additional ingredient therein.

The receptacles are then separated, and the formed patty should remain in one of the receptacles. But, because the patty material is usually damp and sticky and because the patty portions may not integrate into a single patty when the receptacles close together, one of the receptacles may include a release mechanism, operable when the receptacles are together, to release its patty portion, enabling the two patty portions to hold together and not separate when the receptacles are opened. For example, the one receptacle may be of a non-stick material, such as silicone rubber, and/or may have slight flexibility such that when that receptacle is contacted and moved, it slightly deforms which aids in the release of the respective patty portion from that receptacle.

A formed patty may remain in the one receptacle in which it sets when completed. It is held there by adherence of the patty material and by the absence of an air pocket beneath the patty because air was squeezed out of the receptacle during the patty formation steps. Therefore, it is desirable to allow air to enter beneath the patty which enables the patty to fall out of the receptacle. For example, the final receptacle may in part be of flexible material, e.g. of a silicone rubber, so that the user may deform the receptacle enough that the patty is freed to separate and to fall out.

Alternatively, each patty receptacle may include a respective device for releasing the patty material from the recess.

To enable eventual release of the completed patty, the one receptacle in which the completed patty is deposited includes a recessed receptacle in the form of a tray as a part of the device that holds the patty and a support on which that receptacle is removably held. The receptacle is lifted off the support tray. Then the completed patty may be delivered off the tray for further handling. To ease release of the patty from the receptacle the receptacle at least in part is of deformable material, as discussed above, to ease the release of the patty. The receptacle may also at least in part be of a non-stick material, such as silicone rubber, to enhance the ability to separate and because it is a deformable material.

In the preferred form, the first and second patty receptacles are hingedly connected, so that they may be swung together and apart around their hinge connection. In the preferred form, the die support for the die or for both dies is a plate that is hinged to one of the patty receptacles so that the die support plate swings the dies into the respective recesses of the receptacles and out again.

Other objects and features of the present invention will become apparent from the following description and the accompanying drawings.

### BRIEF DESCRIPTION OF THE DRAWINGS

FIG. 1 is a top perspective view of an embodiment of the device for installing an ingredient in a burger according to the present invention.

FIG. 2 is a side view thereof.

FIG. 3 is a top view thereof.

FIG. 4 is bottom view thereof.

FIG. 5 is perspective view thereof with the receptacles closed and the dies in their receptacles.

FIG. 6 is a perspective view with the two receptacles closed over each other in the final stage of forming a completed patty.

FIG. 7 is a partial top view showing initially deposited patty portions.

FIG. 8 shows the patty portions with formed ingredients pockets with an additional ingredient in one pocket.

FIG. 9 shows a completed closed patty.

FIG. 10 is a view like FIG. 1, with a receptacle off the device.

### DESCRIPTION OF PREFERRED EMBODIMENT

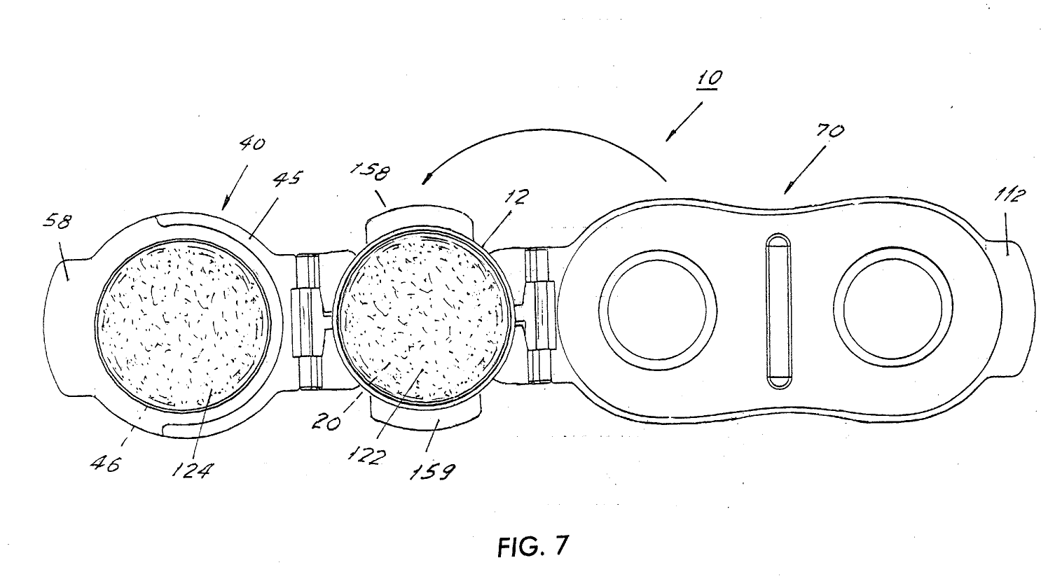

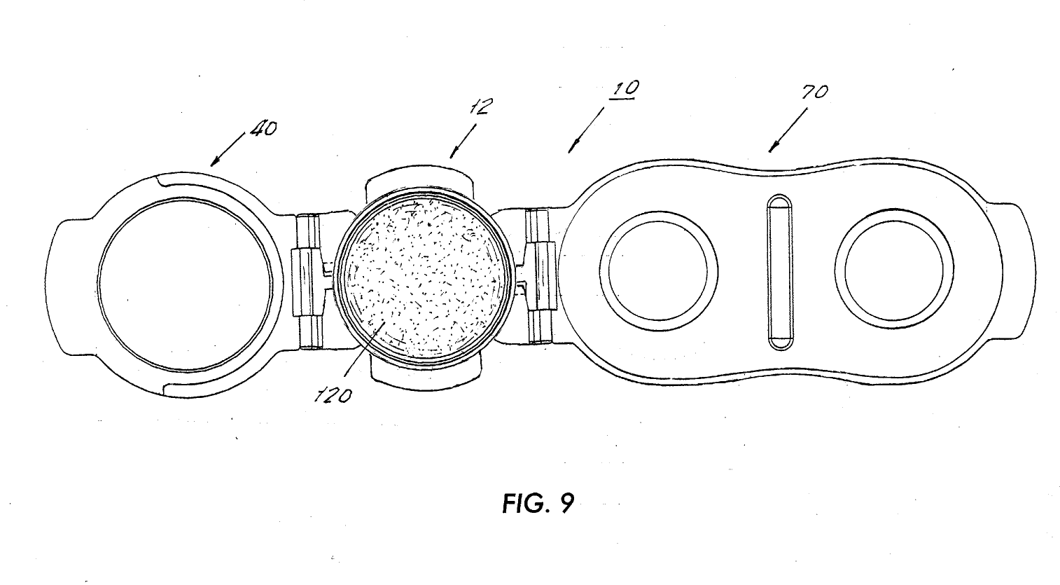

A device 10 for forming a hamburger patty or a patty of other material and for installing additional ingredients according to the present invention includes a first, proximal receptacle part 12 in which the hamburger or patty 120 is eventually completed (FIG. 9). That first part 12 receives a first portion 122 of the patty material (FIG. 7). The first part 12 is articulated to a second, distal receptacle part 40, which receives a second portion 124 of the patty material. The patty shaping die support 70 carries dies for shaping the respective patty portions in their receptacles. All of these parts are preferably formed of a hard, molded plastic material except for the patty portion release device, described below, located in the receptacle part 40.

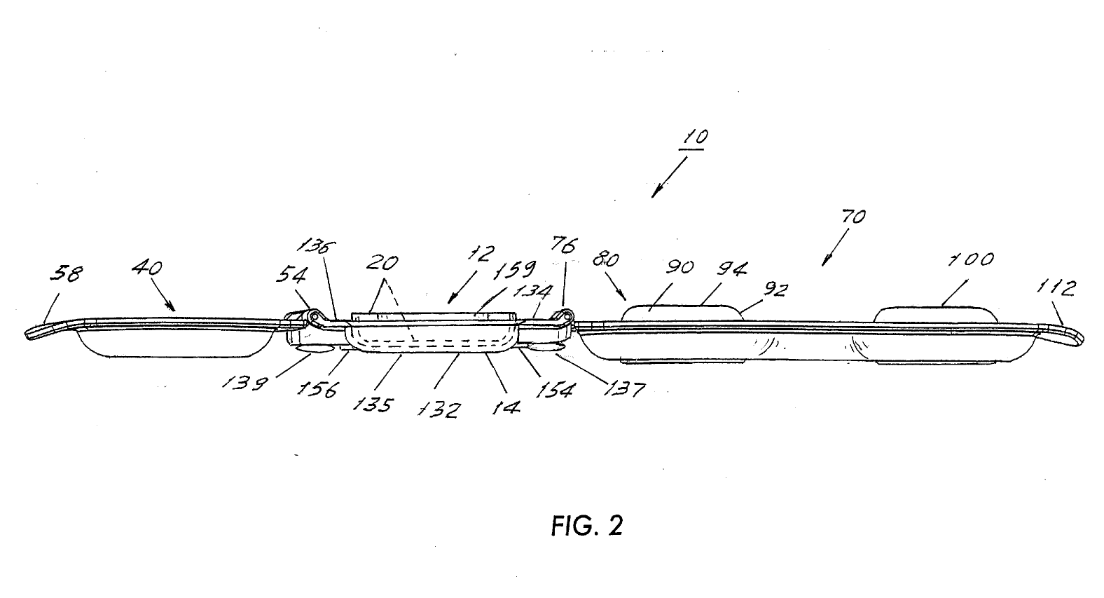

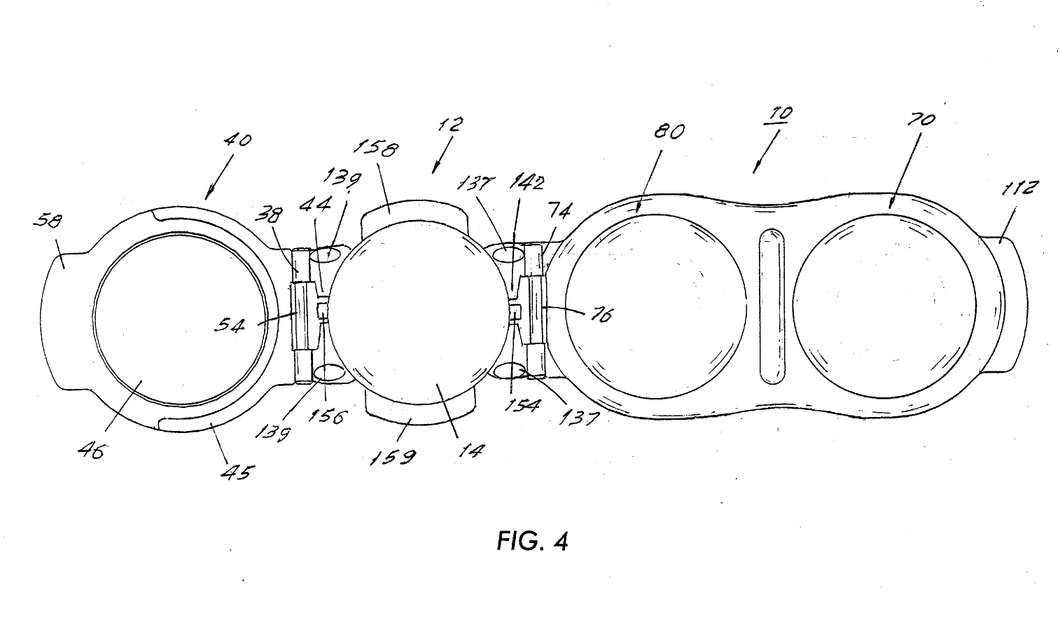

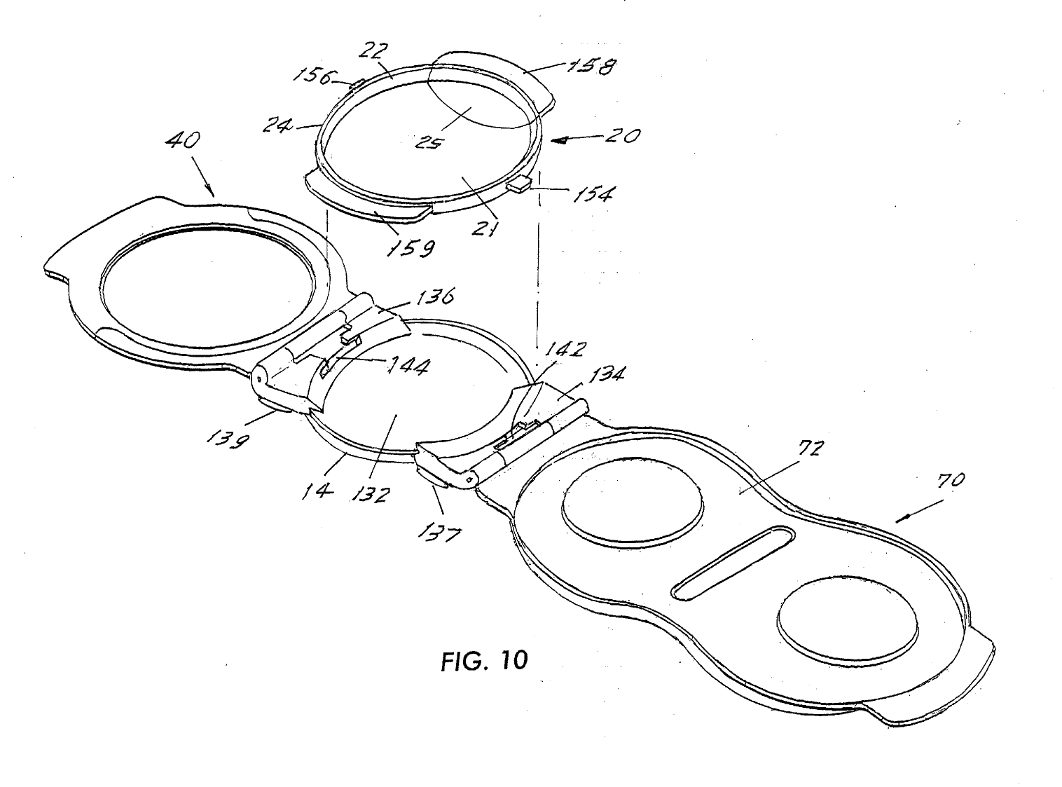

The first, proximal receptacle part 12, as shown in FIGS. 2, 4 and 10, includes a support tray 14 for supporting a receptacle 20, which is described in detail below. As shown in FIGS. 2 and 10, the tray 14 includes a dish shaped base portion 132 which includes end support brackets 134 and 136 by which the tray 14 is articulatedly connected at the hinge 38 and 54 to the distal receptacle part 40 on the one hand and at the hinges 74, 76 to the die support 70 on the other hand. At the base of the brackets 134, 136 on each side of the tray is a respective slot 142, 144, which captures and holds the below described patty receptacle 20 by the lock tabs 154, 156, described below.

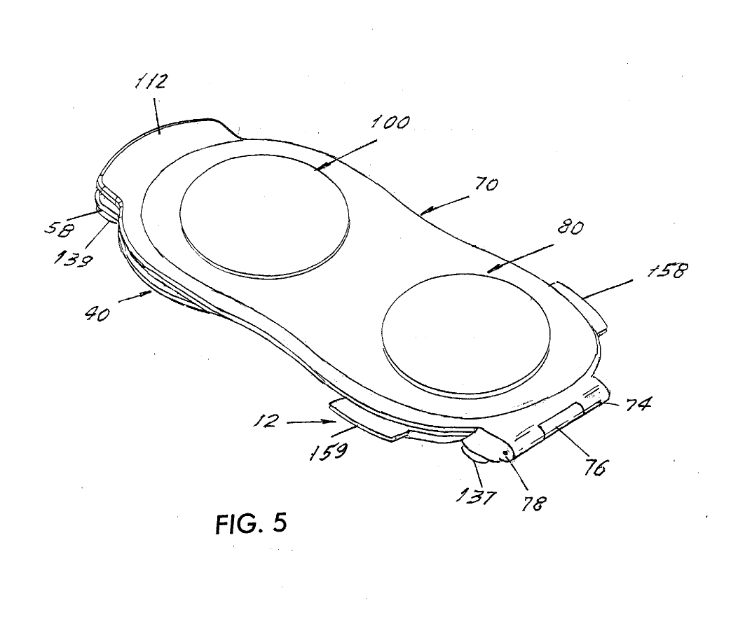

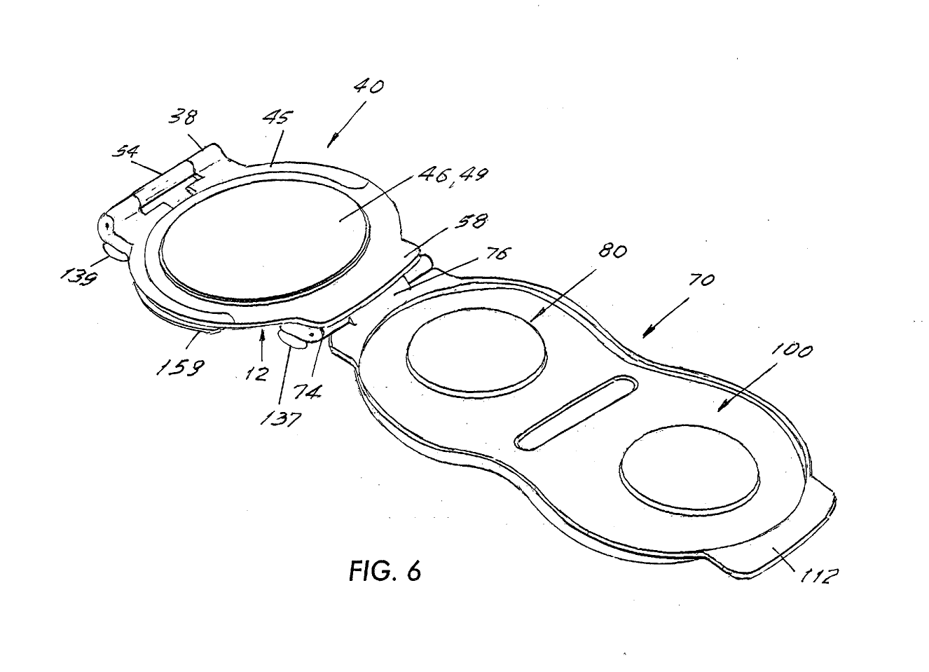

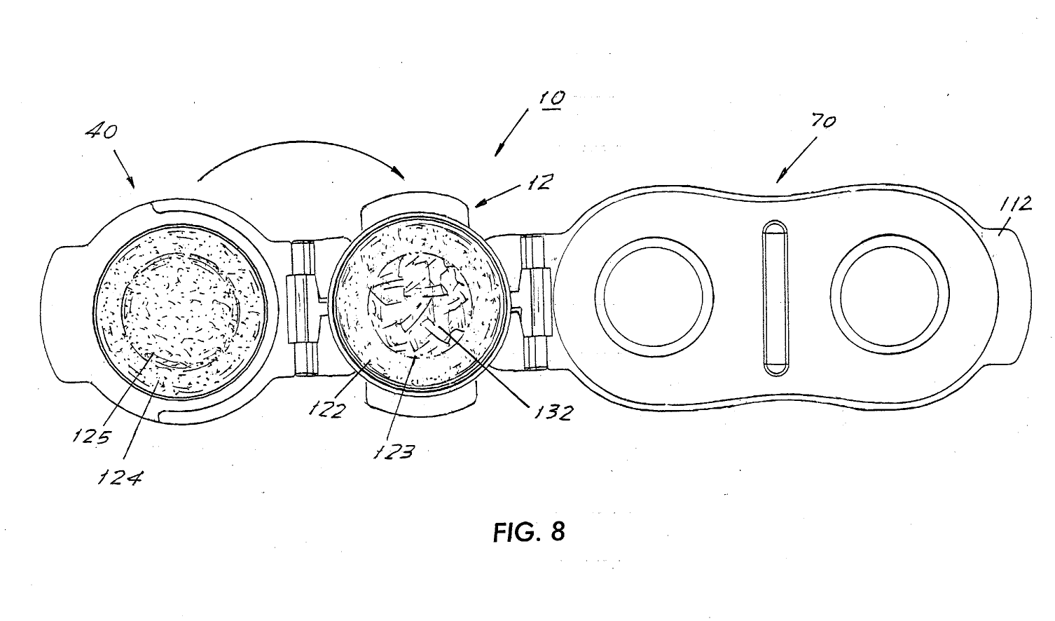

The bottom surface 135 of the tray 14 is shaped to provide a stable support for the device 10 on a surface. Preferably, there are small feet 137 beneath the bracket 134 and 139 beneath the bracket 136, which are spaced out and provide a stable support, along with the surface 135, for the entire device 10, especially when it is operated to form and shape patty portions (FIGS. 5 and 8) and to form the completed patty (FIGS. 6 and 9).

The patty receptacle 20 encloses a dish shaped hamburger patty size and shape recess 21 having upstanding sidewalls 22 which end at their top edge 24. At each side of the tray there are the projecting lock tabs 154, 156 which are shaped and sized to be received in the respective slots 142 and 144. To lock the patty receptacle 20 to the tray 14, the lock tabs 142, 144 are passed into their respective slots, and the tray 20 is rotated then locking the tabs beneath the tray 14.

There are handles 158, 159 on opposite sides of the receptacle 20 which are manually grasped and moved to rotate the tray 20 and also to lift it when the tabs 154, 156 are aligned with their slots 142, 144.

The upper or free edge 24 of the peripheral wall 22 cooperates with the below described cooperating die support plate 72 for shaping the patty portion in the recess 21 and later cooperates with the adjacent second, distal patty receptacle 40 for forming the periphery of the completed patty. As the patty material is typically sticky and adherent and might remain with the receptacle or recess 20 thereof upon completion of forming the patty, removal of the receptacle 20 from the tray 14 (FIG. 10) eases separating the patty from the receptacle. A pivot hinge 38 along a distal edge enables the proximal receptacle part 12 to be hingedly connected to the adjacent distal patty receptacle part 40.

The receptacle part 20 may include a release device for the patty. Such a release device includes at least a portion 25 of the receptacle 20 encompassing one of the handles 158 and part of the bottom of the receptacle. That portion is slightly deformable, and deformation thereof releases surface engagement of the patty and enables air to enter beneath the patty so that it is not retained in the receptacle by an air pressure differential on its surfaces. The portion 125 is of a deformable material and a preferably non-adherent material. Silicone rubber is a preferred material. When the receptacle is free of the tray, the second distal patty receptacle part 40 includes a flat rigid yoke 45 which surrounds a respective receptacle recess 46. The recess 46 has upstanding sides 48 that define an external profile for a burger or patty portion in the recess. The recess terminates at a flat bottom 49. The upper region 52 of the recess 46 is of a diameter such that it closely receives the exterior of the upstanding wall 22 around the tray 20. When the receptacles 20, 46 are eventually closed together (FIG. 6), part 12 over part 40, to finally form the burger, the upper edge 24 of the wall 22 trims off extraneous patty material outward of the recess 20 and the receptacle side 48, and the wall 22 brings the edges of the two formed patty portions 122, 124 together helping to close the edge of the patty 120 and also retains the completed patty within the recess 20 of the part 12 when the receptacle part 40 is reopened after the patty has been formed.

Although the two patty portions should become integrated by the closing together of the receptacle parts 12 and 40, they may not do so for several reasons, including insufficient contact between the patty portions 122, 124 due to inadequate filling of one of the receptacles or greater adherence of the patty material of one patty portion to the surface of its receptacle than to the other patty portion, e.g. due to the dampness or the weight of the material. To avoid the patty portions remaining separated and staying with their respective receptacles, upon the reopening of the receptacles, one of several devices for separating patty material from its receptacle may be provided, as described below.

At the proximal edge of the yoke 45 is a cooperating swing hinge element 54 which together with the hinge elements 38 and the hinge pin 56 forms a hinge connection between the receptacle parts 12 and 40. Both receptacles 20 and 46 are generally in a common plane.

The distal edge of the receptacle 46 includes a grip 58 by which the second receptacle part 40 may be closed toward and opened away from the first receptacle part 12 and also enables cooperation with a grip 112 on the below described die support 70 for enabling later opening of the patty forming device after the patty portions have been shaped.

For convenience in separating the partially formed patty, that is, the patty portion, from the receptacle part 40 and for assuring that the completed patty will finally reside in the first receptacle part 12 (FIG. 9), in one preferred embodiment at least the major part of the receptacle part 40 i.e. other than the yoke 45, is not formed of rigid material, but rather is of a somewhat flexible, resilient material and/or of a material with good release properties for releasing the patty material. In one preferred form, distal of the hinge 38, 54, the part 40 has a rigid plastic support yoke 45, which supports the remaining elements of the part 40. These elements include the receptacle and recess 46, 48, and 49, and the grip 58. During the final reopening step to separate the receptacles 20, 46, the grip 58 is pulled, which deforms the non-rigid part and causes the patty material to separate from that receptacle 46 and thereby to remain with the patty material in the other receptacle part 12. This separation is aided by those remaining elements of the receptacle 40 of the part, particularly in the recess 46, being of a release material, such as silicone rubber.

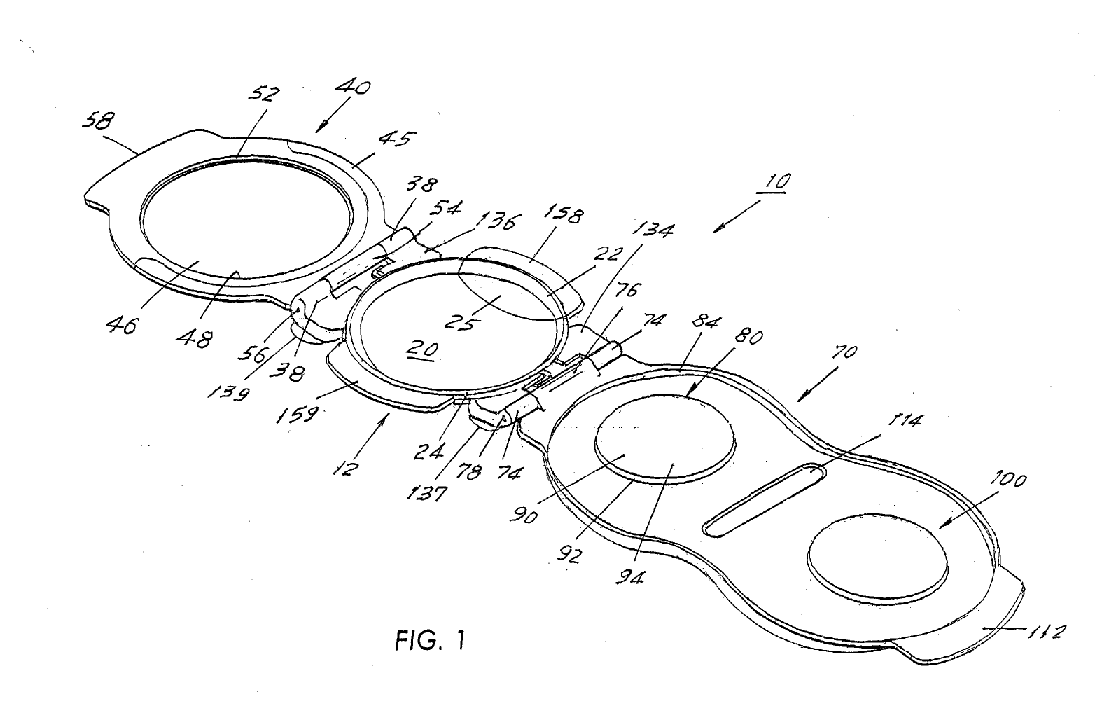

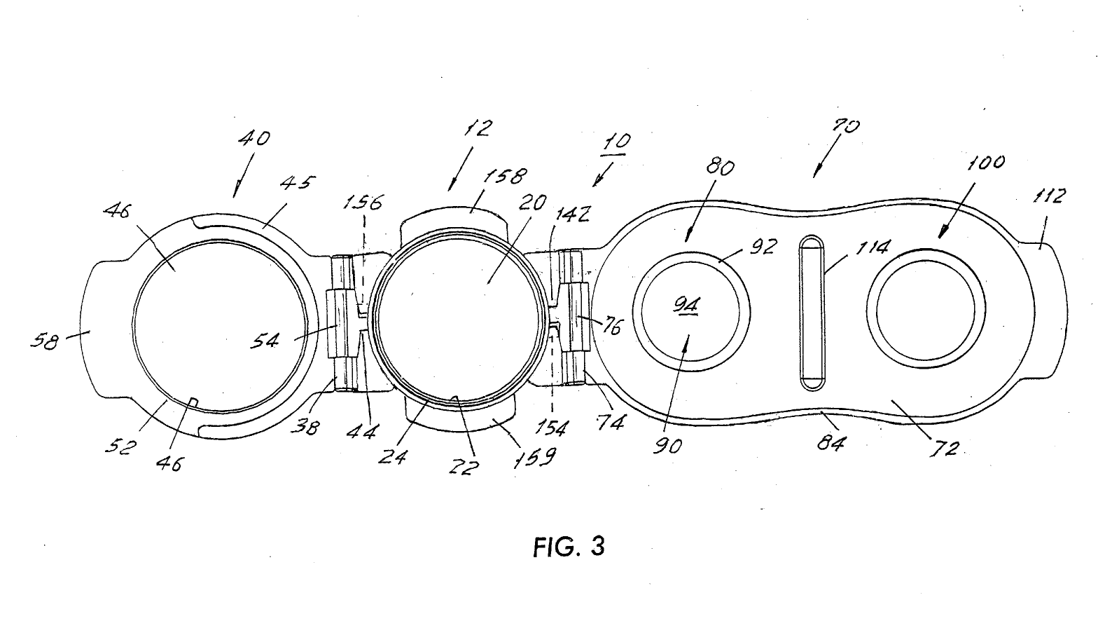

A patty shaping, die support device 70 includes the stiff die support plate 72 with both a proximal 80 and distal 100 shaping die formed in it. The proximal end of the first proximal receptacle part 12 is provided with hinge elements 74, and the plate 72 includes cooperating hinge element 76. Those hinge elements are joined by the hinge pin 78 so that the plate 72 may be hingedly pivoted between the open position illustrated in FIGS. 1 and 3 and a closed position illustrated in FIG. 5 wherein each of the dies 80 and 100 is installed in its respective patty recess 16, 46.

A proximal patty shaping die 80 is positioned on the plate 72 so that the die 80 is received in the patty receptacle 20. The side edge 84 of the plate 72 is elevated above the plate 72 to trim off patty material that is expressed out from the receptacle 20 as the die 80 is closed over and pushed into that recess.

Inward from the side 84, the die 80 includes a patty material shaping dome 90 with rounded sides 92 and a flat top 94. The dome 90 is spaced inwardly from the sides 22 of the recess 20 so that a pocket 123 may be formed in the exposed top side of the patty portion 122 (FIG. 8).

The distal shaping die 100 is supported on the plate 72 in position to be received in the distal receptacle 46. The die 100 has the same shape and size as the die 80. As the die 100 enters the recess 46, it may define a pocket 125 in the exposed top side of the respective patty portion 124 (FIG. 8).

The plate 72 has an additional recess 114 therein shaped and positioned to receive the hinge 38, 54 when the die support plate 70 is closed over the receptacle parts 12 and 40.

The support 70 has a grip 112 at its distal end. The grip moves the plate 72 in order to move the die support 70 over the recesses 20 and 46 and to squeeze the dies and patty portions together, in cooperation with the grip 58 on the distal end of the plate 42, and the grip 112 is used to separate the die support 70 from the other receptacle parts, perhaps in cooperation with the grip 58.

The device 10 has been designed for simplicity of use, and its operation is now described.

The device 10 is placed on a surface, and is fully opened, receptacles facing upward, as in FIG. 1. A first 122 and a second 124 portion of hamburger meat or other patty material is respectively placed in the recess 20, 22 and in the recess 46, respectively, as seen in FIG. 7. The installed patty material need not be flattened or smoothed in the receptacles, but there should be enough patty material in the receptacles that when the dies 80 and 100 are moved into the respective receptacles, the dies 80 and 100 can shape the installed patty material as in FIG. 8 and form pockets in the patty portions. Excess patty material will be squeezed or expressed out the side of the recesses when the dies are pressed into them.

The grip 112 is moved to swing the die plate 72 around the hinge 74, 76 to bring the dies 80 and 100 over the receptacles 20 and 46 to close the receptacles as seen in FIG. 5, with the patty portions inside the receptacles. The support plate 70 can be pushed down as the device 10 sits on a surface and/or the grips 112 and 58 can be finger squeezed together to press the dies into the portions of patty material. If there is more patty material than fills the recesses, the patty material will push out sideways and the sides of the recesses will cut off and form an edge for each patty portion.

After the grips 112 and 58 have been squeezed together and the dies have deformed the patty portions, the die plate 72 is swung back to the open condition of FIG. 8. Now the tray and receptacle each contain a respective portion 122, 124 of patty material with a respective pocket or recess 123, 125 in the top, open side thereof, which had been defined by the dies 80 and 100. The user installs ingredients 132 in one 123 or both 123, 125 pockets in one or both patty portions, here shown in pocket 125, possibly including an ingredient that is unlikely to fall out of the pocket 125 in the patty portion in recess 46, and an ingredient that might drip or fall out of the pocket 123 in the patty portion in the not normally inverted recess 20. Ingredients might include, but are not limited to, spices, such as salt, pepper, garlic, and other spices that persons are likely to use with hamburgers or other patty material, vegetable material including tomatoes, beans or other vegetables, cheese, other meat products, such as bacon, ham, or beef and other flavoring items. Once the ingredients have been installed in the pockets that have been defined in the patty portions, the distal receptacle part 40 is gripped by the grip 58 and is swung at the hinge 38, 54 over the patty portion in the receptacle 20, as seen in FIG. 6. The two patty portions and the pockets 123,125 in the patty portions, possibly with installed ingredients, are now closed over each other. Any excess patty material that has been squeezed out of the recesses by the two recesses being closed together is cut off by the edge 24 of the recess 20, which also completes closure of the edge of the patty with the ingredients captured within.

Next, the receptacle part 40 is again swung off the tray 16. The overlaid patty portions with the ingredients between them should form a unitary patty 120 in the receptacle 20, as seen in FIG. 9. To assure that the patty formed in the receptacle 46 will stay in it and so that the patty portion in the receptacle 46 or the entire patty of the combined patty portions is not be lifted up by adherence of the patty portion in the recess 46, one preferred embodiment comprises the non-stick and/or flexible parts 58, 52, 46, 48 of the receptacle 40. When the grip 58 is lifted to raise the receptacle 40, the slight deformation of the adjacent flexible parts separates the receptacle from the patty portion to enable the thus released patty portion to stay on or fall on the other patty portion. This is aided by the non-stick property of that area of the receptacle 40. If the patty or patty portion had been adhering in the receptacle 46, it would fall out of that receptacle and stay in the tray 14.

The patty thus formed may now be removed. The receptacle 20 is rotated by the handles 58 to free the tabs 154, 156 of the receptacle 20 through the slots 142, 144, which frees the receptacle 20, 22 from the tray 14, as seen in FIG. 10. The receptacle 20 can be easily removed from the tray 14. Release of the patty from the recess and receptacle 20, 22 is eased by perhaps inverted the receptacle open side down and additionally by manipulating the handle 158 and the portion 125 of the receptacle to release the patty, and possibly to get air under the patty which aids its release.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A device for providing a food patty with an ingredient disposed inside the patty, the device comprising:
a first patty material receptacle including a first recess for receiving a first portion of patty material therein;
a second patty material receptacle including a respective second recess for receiving a second portion of patty material therein, and the first and second recesses being shaped for being disposed one upon the other with the recesses facing each other;
a common support; first and second patty material shaping dies on the common support, each die including a pocket forming part thereon which is shaped for forming a pocket in the portion of patty material in the respective recess; the support being movable for disposing the first and second dies thereon into the first and second recesses respectively, so that the dies may cooperate with the recesses for shaping the portion of patty material in each recess to define a pocket in the portion of patty material.

2. The device of claim 1, further comprising a hinged connection between the first and the second receptacles enabling the receptacles to be swung apart to expose the recesses therein and enabling the receptacles to be swung together to close one recess over the other.

3. The device of claim 2, further comprising a second hinged connection between one of the receptacles and the common support, enabling the common support to be opened away from the receptacles and enabling the common support to be swung closed over the first and second recesses, the second hinged connection and the location of the dies on the common support being such that with the die support closed over the receptacles, each of the first and second dies projects into the respective one of the first and second recesses.

4. The device of claim 1, further comprising a release device on at least one of the receptacles operable to release patty material from the recess of that receptacle.

5. The device of claim 4, wherein the release device comprises the one receptacle being comprised of a non-stick material.

6. The device of claim 4, wherein the one receptacle is further comprised of a deformable material such that patty material may be released from the one receptacle by the deformation thereof.

7. The device of claim 1, wherein the first receptacle is further comprised of a deformable material such that manually moving the one receptacle off the other receptacle deforms the one receptacle such that patty material may be released from the one receptacle by the deformation thereof.

8. A device for providing a food patty with an ingredient disposed inside the formed patty, the device comprising:
a first patty material receptacle including a first recess for receiving a first portion of patty material therein;
a second patty material receptacle including a respective second recess for receiving a second portion of patty material therein, and the first and second recesses being shaped for being disposed one upon the other with the recesses facing each other;
a patty material shaping die and a support for the die, the die including a pocket forming part thereon which is shaped for forming a pocket in the portion of patty material in one of the recesses; the support being movable for disposing the die into the one recess so that the die may cooperate with the recess for shaping the portion of patty material in the recesses to define a pocket in the patty for receiving an additional ingredient.

9. The device of claim 8, further comprising a release device for patty material in the first receptacle.

10. The device of claim 9, wherein the release device comprises the first receptacle being comprised of a non-stick material.

11. The device of claim 10, wherein the first receptacle is further comprised of a sufficiently flexible material that manually moving the first receptacle off the second receptacle deforms the first receptacle such that patty material may be released from the first receptacle by the deformation thereof.

12. The device of claim 9, wherein the first receptacle is further comprised of a sufficiently flexible material that manually moving the first receptacle off the other receptacle deforms the first receptacle such that patty material may be released from the first receptacle by the deformation thereof.

13. The device of claim 9, wherein the second receptacle comprises a recessed receptacle for receiving and holding patty material and a tray support for the recessed receptacle, and the recessed receptacle is removably attached to the tray support.

14. The device of claim 13, wherein the second receptacle includes at least a portion thereof that is deformable for aiding release of a patty from the recessed receptacle.

15. The device of claim 8, wherein the second receptacle comprises a recessed receptacle for receiving and holding patty material and at least a portion of the second receptacle includes at least a portion thereof that is deformable for aiding release of a patty from the recessed receptacle.

16. A method for forming a food patty with an additional ingredient inside the patty, the method comprising:
placing first and second portions of patty material in respective separate first and second patty material receptacles;
shaping the first portion of the patty material disposed in at least the first of the receptacles at an exposed surface of the first portion of patty material by applying a pocket forming die to the exposed surface of the patty material in the first receptacle, thereby forming a pocket in the exposed surface of the patty material in the first receptacle;
removing the die from the first receptacle;
placing an additional ingredient in the pocket formed in the patty material;
moving the first and second receptacles with their portions of patty material, each with an exposed face of the receptacle outward, to bring the portions of patty material together, to define a completed patty with the additional ingredient in the patty.

17. The method of claim 16, wherein the die is hingedly swung toward and away from the receptacles and the two receptacles are hingedly swung to move the receptacles.

18. The method of claim 16, further comprising after defining a completed patty, separating the receptacles and depositing the patty in the second receptacle.

19. The method of claim 18, wherein during the separating, deforming the first receptacle so as to release patty material that might remain with the first receptacle for causing the completed patty to remain in the second receptacle.

20. The method of claim 18, wherein after the separating, releasing the patty material from the second receptacle.

21. The method of claim 20, wherein the releasing after separating comprises deforming the second receptacle for releasing the patty therefrom.

22. The method of claim 18, wherein the second receptacle comprises a recessed receptacle supported on a tray support, the method comprising:
upon the completed patty remaining in the second receptacle, removing the recessed receptacle from the tray support.
